(19) United States
(12) Patent Application Publication
(10) Pub. No.: US 2026/0136103 A1
(43) Pub. Date: May 14, 2026

(54) SIGNAL CONVERSION DEVICE, SIGNAL CONVERSION METHOD, AND NON-TRANSITORY COMPUTER-READABLE STORAGE MEDIUM

(71) Applicant: HEIWA SEIKI KOGYO CO., LTD., Saitama (JP)

(72) Inventor: Koichi YAMAGUCHI, Saitama (JP)

(21) Appl. No.: 19/382,659

(22) Filed: Nov. 7, 2025

(30) Foreign Application Priority Data
Nov. 8, 2024 (JP) 2024-195601

(51) Int. Cl. H04N 23/695; H04N 23/90

(52) U.S. Cl. CPC H04N 23/695; H04N 23/90

(57) ABSTRACT

A signal conversion device (40) comprising:
a first acquisition unit that acquires each of N (where N is an integer of 2 or more) first control signals (S1) for respectively controlling N first imaging devices; and
a conversion unit that converts each of the first control signals (S1) acquired by the first acquisition unit into a column control signal (Sc) for changing a height of a column in a holding device (20) capable of holding each of the N first imaging devices (10);
wherein each of the N first control signals (S1) is a signal generated in a corresponding one of N first operating devices (30) respectively corresponding to the N first imaging devices (10) and transmitted from the first operating device (30) by a first communication scheme; and
wherein each of the N first control signals (S1) corresponds to a different protocol (P1) for controlling a corresponding one of the N first imaging devices (10).

### TECHNICAL FIELD

The present invention relates to technology for controlling a support device that holds an imaging device.

### BACKGROUND ART

Various support devices used to hold an imaging device (e.g., a camera) have been proposed. For example, Patent Document 1 discloses a support device including a camera holding portion for holding a camera, a pole portion that is extendable and retractable with the camera holding portion provided at its distal end, and legs. In Patent Document 1, extension and retraction of the pole portion are operated using an operating device (a so-called remote controller).

On the other hand, Patent Document 2 discloses an operating device for remotely controlling an imaging device. For example, panning rotation, tilting rotation, and zooming (enlargement and reduction) of the imaging device are operated by the operating device. As described above, it is common that an operating device for controlling an imaging device and an operating device for controlling a support device exist separately.

### PRIOR ART DOCUMENTS

### Patent Documents

[Patent Document 1] JP 2024-072215 A

[Patent Document 2] JP 2023-161515 A

### SUMMARY OF THE INVENTION

### Problems to be Solved by the Invention

However, when the operating device for controlling the support device is separate from the operating device for controlling the imaging device, it is necessary to manage two operating devices, and for example, when changing the shooting location (installation location of the imaging device), both operating devices must be carried. In view of these circumstances, the object of the present invention is to control the height of a column without using a dedicated operating device.

### Means for Solving the Problems

[1] A signal conversion device comprising:

a first acquisition unit that acquires each of N (where N is an integer of 2 or more) first control signals for respectively controlling N first imaging devices; and
a conversion unit that converts the first control signal acquired by the first acquisition unit into a column control signal for changing the height of a column in a holding device capable of holding each of the N first imaging devices,
wherein each of the N first control signals is a signal generated in each of N first operating devices corresponding respectively to the N first imaging devices and transmitted from the respective first operating device by a first communication scheme, and wherein each of the N first control signals corresponds to a different protocol for controlling the respective N first imaging devices.

[2] The signal conversion device according to [1],
wherein the holding device is capable of holding a second imaging device,
further comprising a second acquisition unit that acquires a second control signal for controlling the second imaging device,
wherein the conversion unit converts the second control signal acquired by the second acquisition unit into the column control signal,
and wherein the second control signal is a signal generated in a second operating device corresponding to the second imaging device and transmitted from the second operating device by a second communication scheme different from the first communication scheme.

[3] The signal conversion device according to [1] or [2],
wherein, among the N first control signals converted into the column control signals for instructing to raise the height of the column, the instructions represented by the first control signals with respect to the first imaging device are common,
and wherein, among the N first control signals converted into the column control signals for instructing to lower the height of the column, the instructions represented by the first control signals with respect to the first imaging device are common.

[4] The signal conversion device according to any one of [1] to [3],
wherein the first imaging device is capable of panning rotation and tilting rotation,
and wherein, when the first acquisition unit acquires a first control signal for instructing upward rotation in the tilting rotation, the conversion unit converts the first control signal into a column control signal for instructing to raise the height of the column,
and when the first acquisition unit acquires a first control signal for instructing downward rotation in the tilting rotation, the conversion unit converts the first control signal into a column control signal for instructing to lower the height of the column.

[5] The signal conversion device according to any one of [1] to [4],
which is attachable to and detachable from the holding device.

The signal conversion device according to any one of [1] to [5],
wherein the first acquisition unit acquires, together with the first control signal, a third control signal representing a speed related to a predetermined operation of the first imaging device corresponding to the first control signal,
and wherein the conversion unit converts the third control signal acquired by the first acquisition unit into a column speed signal for instructing a moving speed of the column.

A signal conversion method implemented by a computer, comprising:
acquiring each of N first control signals for respectively controlling N first imaging devices, where N is an integer of 2 or more;
converting each of the acquired first control signals into a column control signal for changing a height of a column in a holding device capable of holding each of the N first imaging devices;
wherein each of the N first control signals is a signal generated in a corresponding one of N first operating devices respectively corresponding to the N first imaging devices and transmitted from the first operating device by a first communication scheme; and wherein each of the N first control signals corresponds to a different protocol for controlling a corresponding one of the N first imaging devices.

A non-transitory computer-readable medium storing instructions that, when executed by a computer, cause the computer to:
acquire each of N first control signals for respectively controlling N first imaging devices, where N is an integer of 2 or more; and
convert each of the first control signals acquired by the first acquisition unit into a column control signal for changing a height of a column in a holding device capable of holding each of the N first imaging devices;
wherein each of the N first control signals is a signal generated in a corresponding one of N first operating devices respectively corresponding to the N first imaging devices and transmitted from the first operating device by a first communication scheme; and
wherein each of the N first control signals corresponds to a different protocol for controlling a corresponding one of the N first imaging devices.

### Effect of Invention

According to the present invention, the height of the column can be controlled without using a dedicated operating device.

### BRIEF DESCRIPTION OF THE DRAWINGS

FIG. 1 A perspective view of an imaging system according to the first embodiment.

FIG. 2 A block diagram illustrating a functional configuration of a signal conversion device according to the first embodiment.

FIG. 3 A schematic diagram illustrating a relationship between N operating devices and the signal conversion device according to the first embodiment.

FIG. 4 A schematic diagram illustrating a conversion table stored in a storage device according to the first embodiment.

FIG. 5 A flowchart illustrating an example of signal conversion processing according to the first embodiment.

FIG. 6 A block diagram illustrating a functional configuration of a signal conversion device according to the second embodiment.

FIG. 7 A schematic diagram illustrating a relationship between K operating devices and the signal conversion device according to the second embodiment.

### EMBODIMENTS FOR CARRYING OUT THE INVENTION

### FIRST EMBODIMENT

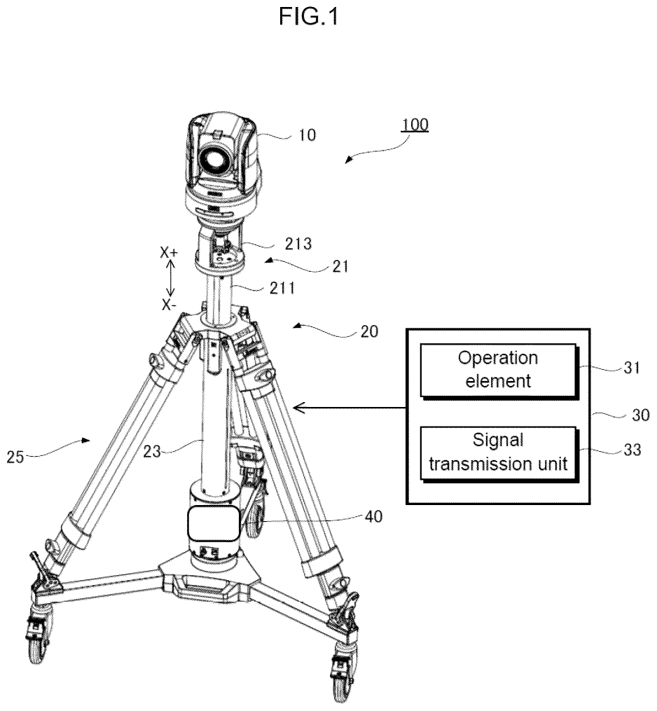

FIG. 1 is a perspective view of an imaging system 100 according to the first embodiment. As illustrated in FIG. 1, the imaging system 100 includes an imaging device 10, a holding device 20, a first operating device 30, and a signal conversion device 40.

The imaging device 10 (an example of the “first imaging device”) is an imaging apparatus (for example, a camera) that can be operated remotely. In the first embodiment, an imaging device 10 capable of performing panning rotation, tilting rotation, and zooming (enlargement and reduction) (for example, a PTZ camera) is illustrated as an example. The panning rotation (rotation in a horizontal direction) can also be described as rotation to the left and right, and the tilting rotation (rotation in a vertical direction) can also be described as rotation upward and downward. The imaging device 10 is held by the holding device 20.

The holding device 20 is an apparatus for holding the imaging device 10. The holding device 20 of the first embodiment includes, for example, a column 21, a housing part 23, and legs 25.

The column 21 is a portion to which the imaging device 10 is connected at its distal end. The column 21 of the first embodiment includes, for example, a pole part 211 and a connecting part 213. The connecting part 213 is a portion that is connected to the imaging device 10. Specifically, the connecting part 213 is, for example, a portion to which a connecting instrument (such as a tripod head or an adapter) directly connected to the imaging device 10 is attached, and is a mechanism for indirectly holding the imaging device 10 via the connecting instrument.

The pole part 211 is a shaft-shaped member extending in the X direction and is extendable and retractable along the X direction (an example of a vertical direction). A connecting part 213 is provided at the distal end (the positive (+) end in the X direction) of the pole part 211. The entire column 21 moves in the vertical direction (the X direction in FIG. 1). That is, the column 21 can change its height (the position of the positive (+) end in the X direction of the column 21). It can also be said that the column 21 is extendable and retractable. By changing the height of the column 21, the height of the imaging device 10 provided at the distal end of the column 21 can be changed. The height of the column 21 and the moving speed of the column 21 (the speed when the column 21 rises and descends) can be arbitrarily set by a user. The method for changing the height of the column 21 will be described later.

The housing part 23 is a tubular container that supports the column 21 so that its height can be changed (moved in the vertical direction) inside. A drive unit (not shown) for changing the height of the column 21 is housed, for example, inside the housing part 23. The drive unit is, for example, a motor. Any known technique (for example, the technique described in JP 2024-072215 A) may be adopted as the configuration for extending and retracting the column 21.

The legs 25 are connected, for example, to an end of the housing part 23 (the positive (+) end in the X direction). In FIG. 1, a case where the legs 25 are a tripod that is extendable and retractable is illustrated as an example; however, the configuration of the legs 25 is not particularly limited (for example, a monopod or non-extendable legs may also be used).

The first operating device 30 is an operating apparatus for controlling the imaging device 10 held by the holding device 20. For example, panning rotation, tilting rotation, or zooming (enlargement and reduction) of the imaging device 10 can be operated by the first operating device 30. As illustrated in FIG. 1, the first operating device 30 of the first embodiment includes an operation element 31 operated by a user and a signal transmission unit 33. The operation element 31 may be either a physical operation member or a touch panel that detects contact by the user.

For example, the first operating device 30 includes an operation element 31 for panning rotation (an operation element for rotation to the right and an operation element for rotation to the left), an operation element 31 for tilting rotation (an operation element for rotation upward and an operation element for rotation downward), an operation element 31 for zooming (an operation element for enlargement and an operation element for reduction), an operation element 31 for adjusting the speed of panning rotation, and an operation element 31 for adjusting the speed of tilting rotation. Each operation element 31 may be a separate operation element, or, in the case of a physical operation element, a lever-type operation element may have multiple functions (for example, functions as an operation element for panning rotation and as an operation element for tilting rotation).

The signal transmission unit 33 generates and transmits to the imaging device 10 a signal (hereinafter referred to as a “first control signal”) S1 for controlling the imaging device 10. Specifically, when an operation of the operation element 31 by the user is accepted, a first control signal S1 instructing the imaging device 10 to perform an operation corresponding to the user's operation is transmitted to the imaging device 10. For example, when an operation element for rotation to the right is selected, a first control signal S1 instructing rotation to the right is transmitted to the imaging device 10. The imaging device 10 that receives the first control signal S1 performs the operation instructed by the first control signal S1.

The function of the signal transmission unit 33 is realized by one or more processors, such as a CPU (Central Processing Unit), GPU (Graphics Processing Unit), SPU (Sound Processing Unit), DSP (Digital Signal Processor), FPGA (Field Programmable Gate Array), or ASIC (Application Specific Integrated Circuit). Alternatively, the function of the signal transmission unit 33 may be realized by a microcomputer (microcomputer or microcontroller).

In the first embodiment, the first operating device 30 transmits the first control signal S1 to the imaging device 10 by a first communication scheme. The first communication scheme of the first embodiment is, for example, a serial communication scheme. Serial communication is a communication method in which data is transmitted sequentially, one bit at a time. The connection method between the imaging device 10 and the first operating device 30 is typically wired and connected by various cables. When the imaging device 10 and the first operating device 30 are connected by wire, examples of the serial communication standards include RS-232, RS-485, RS-422, and UART. However, depending on the type of the first communication scheme, the imaging device 10 and the first operating device 30 may also be connected wirelessly. When the imaging device 10 and the first operating device 30 are connected wirelessly, they are connected through, for example, short-range wireless communication (infrared communication, Bluetooth (registered trademark), Wi-Fi (registered trademark)) or a communication network such as the Internet.

Here, in a configuration in which the first operating device 30 for controlling the imaging device 10 and an operating device for controlling the holding device 20 (the column 21) are provided separately, the user needs to use and manage two operating devices, which is inconvenient for the user. In view of these circumstances, in the present invention, the column 21 of the holding device 20 is operated by using the first operating device 30 for controlling the imaging device 10. A signal conversion device 40 is used for operating the column 21 by the first operating device 30 for controlling the imaging device 10.

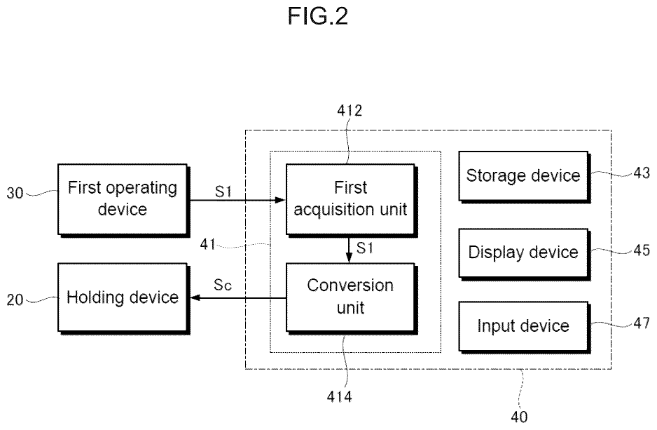

FIG. 2 is a block diagram illustrating a functional configuration of the signal conversion device 40. The signal conversion device 40 is a converter that converts a first control signal S1 for controlling the imaging device 10 into a signal Sc (hereinafter referred to as a “column control signal”) for changing the height of the column 21.

The signal conversion device 40 is communicably connected to the first operating device 30 and the holding device 20, respectively. The connection method between the signal conversion device 40 and the first operating device 30, and the connection method between the signal conversion device 40 and the holding device 20, may be either wired or wireless as long as communication is possible. When the user changes the height of the column 21, the first operating device 30 is connected to the signal conversion device 40 for use. As illustrated in FIG. 2, the signal conversion device 40 includes a control device 41, a storage device 43, a display device 45, and an input device 47.

The control device 41 is one or more processors that control respective elements of the signal conversion device 40. The control device 41 operates in accordance with a program stored in the storage device 43. The control device 41 is realized by, for example, a processor such as a CPU (Central Processing Unit) or a DSP (Digital Signal Processor).

The storage device 43 is one or more memories that store a program executed by the control device 41 and various kinds of data used by the control device 41. As the storage device 43, a known recording medium such as a semiconductor recording medium or a magnetic recording medium, or a combination of a plurality of types of recording media, is used. The control device 41 and the storage device 43 may be configured, for example, by a microcomputer (microcomputer or microcontroller).

The display device 45 displays various images under the control of the control device 41. The display device 45 is, for example, a display panel such as a liquid crystal display panel or an organic EL (Electroluminescence) panel. For example, various images used by the user during operation are displayed on the display device 45. The input device 47 is an input device that receives instructions from the user and includes an operation element. The operation element is, for example, an operation element operated by the user or a touch panel that detects contact by the user.

The control device 41 of the first embodiment implements functions (a first acquisition unit 412 and a conversion unit 414) for controlling the height of the column 21.

The first acquisition unit 412 acquires the first control signal S1 transmitted from the first operating device 30. Specifically, the first acquisition unit 412 acquires, for example, the first control signal S1 transmitted from the first operating device 30 by the first communication scheme (serial communication) through a communication module (not shown).

The type of communication module is appropriately changed according to the connection method between the first operating device 30 and the signal conversion device 40. For example, when the first operating device 30 and the signal conversion device 40 are communicably connected by wire, a terminal or the like is exemplified as the communication module. For example, when the first operating device 30 and the signal conversion device 40 are communicably connected wirelessly, a receiving device or the like is exemplified as the communication module. In the following description, a case is illustrated in which the first operating device 30 and the signal conversion device 40 are connected by a cable, and the first control signal S1 is acquired through a terminal (in which a plurality of pins are arranged) provided in the signal conversion device 40.

The conversion unit 414 converts the first control signal S1 acquired by the first acquisition unit 412 into a column control signal Sc. Then, the column control signal Sc is transmitted to the holding device 20. The holding device 20 that has received the column control signal Sc through the communication module controls the height of the column 21 in accordance with the column control signal Sc. The holding device 20 is provided with a control device (not shown) composed of one or more processors for controlling the height of the column 21 of the holding device 20. When the column control signal Sc is received, the height of the column 21 is changed by the control device. The column control signal Sc is transmitted using a protocol that can be received by the holding device 20.

Specifically, the conversion unit 414 converts two types of first control signals S1, which respectively give different instructions to the imaging device 10, into a column control signal Sc for raising the height of the column 21 and a column control signal Sc for lowering the height of the column 21. In the first embodiment, a case is illustrated in which a first control signal S1 for instructing tilting rotation is converted into the column control signal Sc.

When the first acquisition unit 412 acquires a first control signal S1 that instructs rotation in the upward direction, the conversion unit 414 of the first embodiment converts the first control signal S1 into a column control signal Sc that instructs to raise the height of the column 21. When the first acquisition unit 412 acquires a first control signal S1 that instructs rotation in the downward direction, the conversion unit 414 converts the first control signal S1 into a column control signal Sc that instructs to lower the height of the column 21.

Any operation element 31 in the first operating device 30 is used as an operation element for changing the height of the column 21. Specifically, two operation elements 31, which respectively give different instructions to the imaging device 10, are used as an operation element for instructing to raise the height of the column 21 and an operation element for instructing to lower the height of the column 21.

In the first embodiment, the operation element 31 for tilting rotation is used as the operation element for changing the height of the column 21. For example, the operation element 31 for instructing rotation in the upward direction is also used as the operation element for instructing to raise the height of the column 21, and the operation element 31 for instructing rotation in the downward direction is also used as the operation element for instructing to lower the height of the column 21. As described above, when the user wants to change the height of the column 21, the user operates the operation element 31 for tilting rotation of the first operating device 30.

Here, in an actual holding device 20, a plurality of imaging devices 10, for example, those manufactured by different manufacturers, can be held. When the manufacturers are different, the protocols (hereinafter referred to as “first control protocols”) for controlling the imaging devices 10 are often different. Therefore, the signal conversion device 40 of the first embodiment is configured to be compatible with N (N is an integer of 2 or more) different first control protocols.

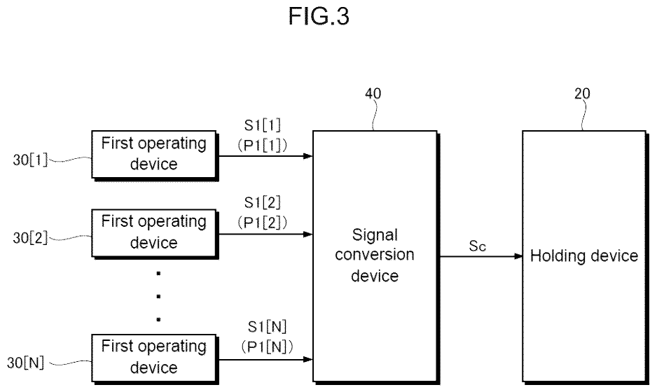

FIG. 3 is a schematic diagram schematically illustrating a relationship between N first operating devices 30, which respectively operate N imaging devices 10, and the signal conversion device 40. It should be noted that N is not particularly limited as long as it is an integer of 2 or more.

Each of the N first operating devices 30 transmits a first control signal S1 for controlling the imaging device 10. The N first control signals S1 transmitted respectively from the N first operating devices 30 correspond to different first control protocols P1. The first control signal S1 is generated based on the first control protocol P1 set in the first operating device 30. In the first embodiment, any known N first control protocols P1 that can be used in the first communication scheme (serial communication) may be adopted. For example, VISCA (Video System Control Architecture), Pelco-D, Pelco-P, NU, and AW are adopted as the first control protocols P1.

In FIG. 3, for convenience of illustration, a state is shown in which N first operating devices 30 are connected in parallel to the signal conversion device 40. However, in practice, among the N first operating devices 30, one first operating device 30 corresponding to the imaging device 10 held by the holding device 20 is communicably connected to the signal conversion device 40. That is, among the N first operating devices 30, the first control signal S1 transmitted from the first operating device 30 communicably connected to the signal conversion device 40 is converted into the column control signal Sc. The user controls the height of the column 21 by using the first operating device 30 corresponding to any one of the imaging devices 10 fixed to the holding device 20 among the N first operating devices 30.

The signal conversion device 40 may be provided with a plurality of terminals for respectively connecting the N first operating devices 30, or may be provided with a single terminal common to the N first operating devices 30. Since the pin arrangement (roles of individual pins) of the terminal may differ for each first control protocol P1, when a single terminal common to the N first operating devices 30 is provided, it is preferable that the control device 41 accepts an instruction from the user to select, among the N first control protocols P1, the first control protocol P1 adopted in the first operating device 30 (the instruction being given by operating the input device 47), and changes the pin arrangement of the terminal in accordance with this instruction. For example, the control device 41 causes an IC (Integrated Circuit) for changing pin arrangements to change the pin arrangement. However, the method for changing the pin arrangement is not limited to the above example.

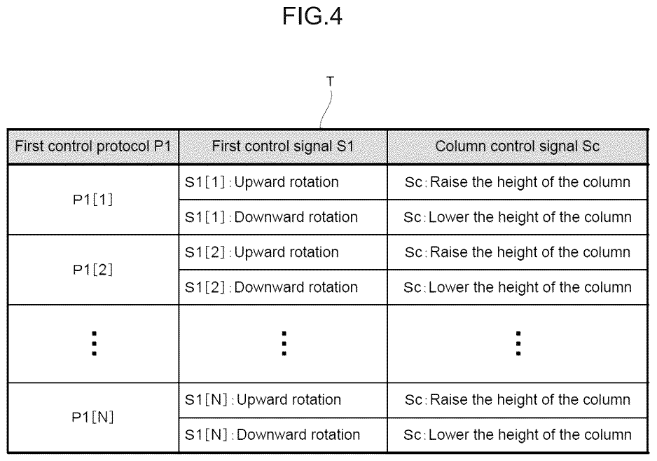

The conversion unit 414 converts the first control signal S1 into the column control signal Sc by referring, for example, to a conversion table T stored in the storage device 43. FIG. 4 is a schematic diagram schematically illustrating the conversion table T. As illustrated in FIG. 4, the conversion table T is a data table in which the first control signal S1 and the column control signal Sc are associated with each other for each first control protocol P1. Specifically, the conversion table T is a data table in which the content represented by the first control signal S1 (an operation instructed to the imaging device 10) is associated with the content represented by the column control signal Sc (an operation instructed to the column 21).

In FIG. 4, an embodiment is illustrated in which, among the N first control signals S1 that are converted into the column control signal Sc for instructing to raise the height of the column 21, the instructions represented by the first control signals S1 to the imaging device 10 (rotation in the upward direction) are common. Similarly, an embodiment is illustrated in which, among the N first control signals S1 that are converted into the column control signal Sc for instructing to lower the height of the column 21, the instructions represented by the first control signals S1 to the imaging device 10 (rotation in the downward direction) are common.

In the above description, N first operating devices 30 having different first control protocols P1 have been assumed. However, in practice, in addition to the N first operating devices 30 having different first control protocols P1, a configuration capable of supporting a plurality of types of first operating devices 30 having a common first control protocol P1 is also adopted. In this configuration, in the conversion table T shown in FIG. 4, the first control signal S1 and the column control signal Sc may be associated for each model. Then, the first control signal S1 transmitted from the first operating device 30 (for example, a signal including an identifier for identifying the model) is converted into the column control signal Sc with reference to the conversion table T.

As understood from the above description, in the first embodiment, the first acquisition unit 412 is an element that acquires each of N first control signals S1 for respectively controlling the N imaging devices 10, and the conversion unit 414 functions as an element that converts the first control signal S1 acquired by the first acquisition unit 412 into a column control signal Sc. Each of the N first control signals S1 is a signal generated in each of the N first operating devices 30 corresponding respectively to the N imaging devices 10 and transmitted from the corresponding first operating device 30 by the first communication scheme.

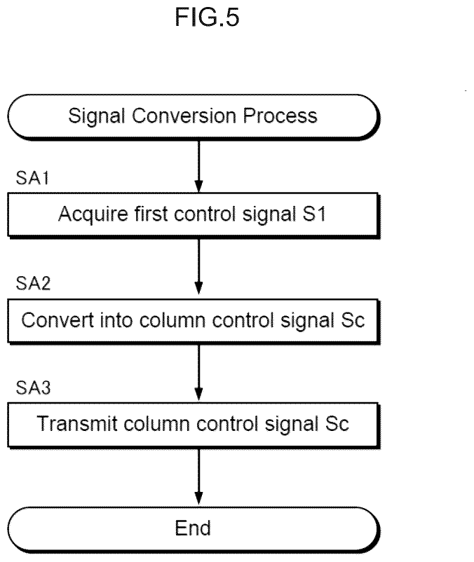

FIG. 5 is a flowchart illustrating an example of processing (hereinafter referred to as “signal conversion processing”) executed by the control device 41 according to the first embodiment. The signal conversion processing is processing for converting (generating) the column control signal Sc from the first control signal S1.

When the signal conversion processing is started, the first acquisition unit 412 acquires the first control signal S1 transmitted from the first operating device 30 (SA1). Next, the conversion unit 414 generates a column control signal Sc in accordance with the first control signal S1 acquired by the first acquisition unit 412 (SA2). Step SA2 can also be described as processing for converting the first control signal S1 into the column control signal Sc. In generating the column control signal Sc, for example, the conversion table T in FIG. 4 is referred to. Specifically, the conversion unit 414 converts the first control signal S1 into the column control signal Sc corresponding to the first control protocol P1 of the first operating device 30 being used and the acquired first control signal S1 in the conversion table T. Then, the conversion unit 414 transmits the generated column control signal Sc to the holding device 20 (SA3). The holding device 20 that has received the column control signal Sc changes the height of the column 21. In practice, each time the first control signal S1 is acquired (received), the series of processes of Step SA1 and Step SA2 are repeatedly executed.

Before starting the signal conversion processing, the user instructs the control device 41, through an operation on the input device 47, which one of the N first operating devices 30 (first control protocols P1) is to be used. That is, the first control protocol P1 of the first control signal S1 to be converted is designated. The control device 41, as necessary, changes the pin arrangement of the terminal, for example, by using an IC.

As understood from the above description, in the first embodiment, since each of the N first control signals S1 corresponding to different first control protocols P1 can be converted into a column control signal Sc, various operating devices having different first control protocols P1 can also be used to operate the column 21. That is, the height of the column 21 can be adjusted without using a dedicated operating device. Therefore, it is not necessary to separately use an operating device for controlling the imaging device 10 and an operating device for controlling the holding device 20, and the effort required to manage both operating devices is reduced.

When operating the imaging device 10, the user uses the operating device in a state where the connection with the signal conversion device 40 is released, and when operating the holding device 20, the user operates the operating device in a state where it is connected to the signal conversion device 40.

### SECOND EMBODIMENT

A second embodiment of the present invention will be described. In the following description, elements having functions similar to those in the first embodiment are denoted by the same reference numerals as those used in the description of the first embodiment, and detailed explanations thereof are omitted as appropriate.

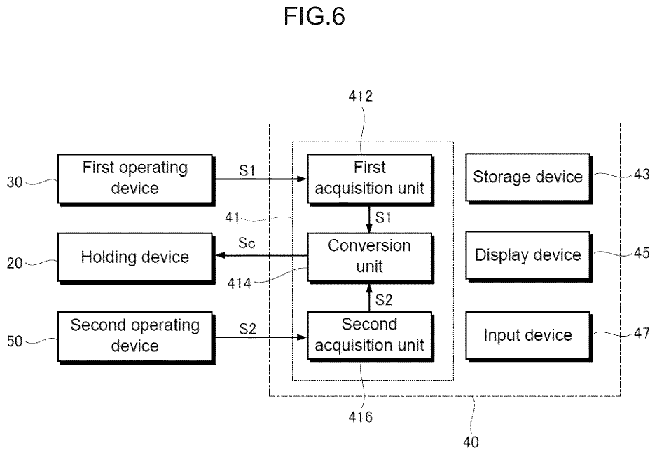

FIG. 6 is a block diagram illustrating a functional configuration of the signal conversion device 40 according to the second embodiment. The signal conversion device 40 of the second embodiment can support an even wider variety of operating devices.

Specifically, in the second embodiment, in addition to converting the first control signal S1 transmitted by the first communication scheme into the column control signal Sc, an embodiment is illustrated in which the second control signal S2 transmitted by a second communication scheme is converted into the column control signal Sc.

The second control signal S2 is transmitted from the second operating device 50. The second operating device 50 is an operating device for controlling the imaging device 10 (an example of the “second imaging device”), and generates the second control signal S2 for controlling the imaging device 10 and transmits it to the imaging device 10. The second operating device 50 may have the same embodiment as that described above for the first operating device 30, except that it transmits the second control signal S2 to the imaging device 10 by the second communication scheme. In the second operating device 50, the operation element for tilting rotation is also used as the operation element for changing the height of the column 21, similarly to the first operating device 30.

The second communication scheme is, for example, IP communication. IP (Internet Protocol) communication is communication that uses a standard (Internet Protocol) used on the Internet. The connection method between the imaging device 10 and the second operating device 50 may be either wired or wireless. In the case of a wired connection, they are connected, for example, by a LAN cable, and in the case of a wireless connection, they are connected through, for example, short-range wireless communication (infrared communication, Bluetooth (registered trademark), Wi-Fi (registered trademark)) or a communication network such as the Internet.

As illustrated in FIG. 6, the control device 41 of the second embodiment functions not only as the first acquisition unit 412 and the conversion unit 414 but also as a second acquisition unit 416.

The second acquisition unit 416 acquires the second control signal S2 transmitted from the second operating device 50. Specifically, the second acquisition unit 416 acquires, for example, the second control signal S2 transmitted from the second operating device 50 by the second communication scheme (IP communication) through a communication module (not shown).

The conversion unit 414 of the second embodiment converts the second control signal S2 acquired by the second acquisition unit 416 into a column control signal Sc.

Then, the column control signal Sc is transmitted to the holding device 20. The holding device 20 that has received the column control signal Sc through the communication module adjusts the height of the column 21 in accordance with the column control signal Sc.

Specifically, the conversion unit 414 respectively converts two types of second control signals S2, which respectively give different instructions to the imaging device 10, into a column control signal Sc for raising the height of the column 21 and a column control signal Sc for lowering the height of the column 21. In the second embodiment, an embodiment is illustrated in which a second control signal S2 for instructing tilting rotation is converted into the column control signal Sc.

When the second acquisition unit 416 acquires a second control signal S2 that instructs rotation in the upward direction, the conversion unit 414 of the second embodiment converts the second control signal S2 into a column control signal Sc that instructs to raise the height of the column 21. When the second acquisition unit 416 acquires a second control signal S2 that instructs rotation in the downward direction, the conversion unit 414 converts the second control signal S2 into a column control signal Sc that instructs to lower the height of the column 21.

As with the first control signal S1, the protocols for controlling the imaging device 10 (hereinafter referred to as “second control protocols”) corresponding to the second control signals S2 are often different. Therefore, the signal conversion device 40 of the second embodiment is configured to be compatible with K (K is an integer of 2 or more) different second control protocols.

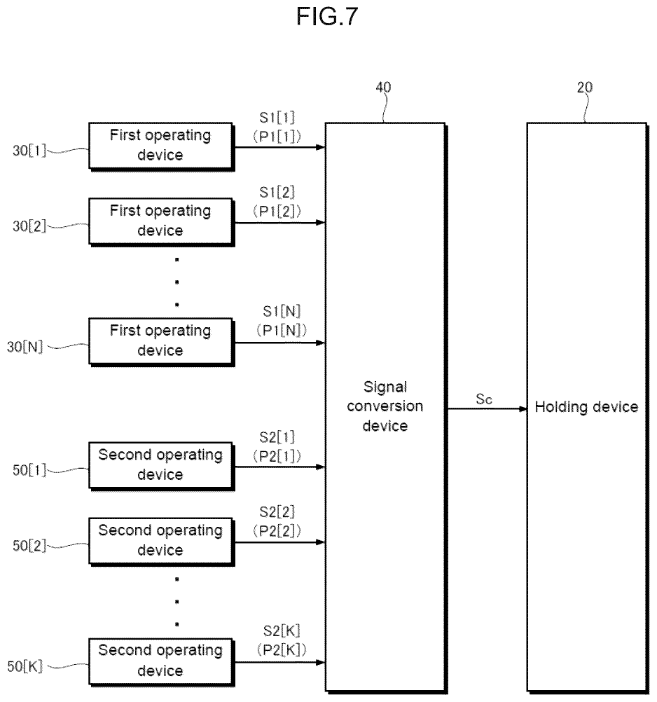

FIG. 7 is a schematic diagram schematically illustrating a relationship between K second operating devices 50, which respectively operate K imaging devices 10, and the signal conversion device 40. K is not particularly limited as long as it is an integer of 2 or more.

Each of the K second operating devices 50 transmits a second control signal S2 for controlling the imaging device 10. The K second control signals S2 transmitted respectively from the K second operating devices 50 correspond to different second control protocols P2. The second control signal S2 is generated based on the second control protocol P2 set in the second operating device 50. In the second embodiment, any known K second control protocols P2 that can be used in the second communication scheme (IP communication) may be adopted. For example, VISCA over IP, HTTP-CGI, XC, and ONVIF are adopted as the second control protocols P2.

In FIG. 7, for convenience of illustration, a state is shown in which the N first operating devices 30 and the K second operating devices 50 are connected in parallel to the signal conversion device 40. However, in practice, among the N first operating devices 30 and the K second operating devices 50, one operating device corresponding to the imaging device 10 held by the holding device 20 is communicably connected to the signal conversion device 40. Accordingly, the user controls the height of the column 21 by using the operating device corresponding to any one of the imaging devices 10 fixed to the holding device 20 among the N first operating devices 30 and the K second operating devices 50.

The conversion unit 414, as in the first embodiment, refers, for example, to a conversion table stored in the storage device 43 to convert the second control signal S2 into the column control signal Sc. The conversion table of the second embodiment is, for example, a data table in which data associating the second control signal S2 and the column control signal Sc for each second control protocol P2 is further added to the conversion table T shown in FIG. 4.

In the above description, K second operating devices 50 having different second control protocols P2 have been assumed. However, in practice, in addition to the K second operating devices 50 having different second control protocols P2, a configuration capable of supporting a plurality of types of second operating devices 50 having a common second control protocol P2 is also adopted. In this configuration, in the conversion table, the second control signal S2 and the column control signal Sc may be associated for each model. Then, the second control signal S2 transmitted from the second operating device 50 (for example, a signal including an identifier representing the model) is converted into the column control signal Sc with reference to the conversion table.

When the holding device 20 (the column 21) is operated by using the second operating device 50, the “first control signal S1” in Step SA1 of the flowchart of the signal conversion processing in FIG. 5 is replaced with the “second control signal S2.”

As understood from the above description, in the second embodiment, the second acquisition unit 416 functions as an element that acquires each of K second control signals S2 for respectively controlling the K imaging devices 10, and the conversion unit 414 functions as an element that converts the second control signal S2 acquired by the second acquisition unit 416 into a column control signal Sc. Each of the K second control signals S2 is a signal generated in each of the K second operating devices 50 corresponding respectively to the K imaging devices 10 and transmitted from the corresponding second operating device 50 by the second communication scheme. However, it is not essential that there are K second operating devices 50 (imaging devices 10) corresponding to different control protocols.

Before starting the signal conversion processing, the user instructs the control device 41, through an operation on the input device 47, which operating device is to be used—the operating device corresponding to the first communication scheme (the first operating device 30) or the operating device corresponding to the second communication scheme (the second operating device 50). Then, the control device 41 switches between a state in which the first control signal S1 can be acquired and a state in which the second control signal S2 can be acquired according to the instruction. For example, the control device 41 switches, as necessary, between a path for acquiring the first control signal S1 (a path for the first communication scheme) and a path for acquiring the second control signal S2 (a path for the second communication scheme).

The same effects as those of the first embodiment are also achieved in the second embodiment. In the second embodiment, in addition to the first operating device 30 corresponding to the first communication scheme, the holding device 20 can also be operated by the second operating device 50 corresponding to the second communication scheme.

### MODIFICATION EXAMPLE

Each of the embodiments illustrated above can be variously modified. Specific examples of modifications applicable to the foregoing embodiments are illustrated below. Two or more of the following examples arbitrarily selected may be appropriately combined as long as they do not conflict with each other.

(1) The holding device 20 to which the present invention is applied is not limited to the embodiments described above. The present invention is applied, for example, to operating the column 21 of a holding device 20 that holds various types of imaging equipment, such as large imaging devices, small imaging devices, remotely operable imaging devices (for example, PTZ cameras), or terminal devices (for example, smartphones) equipped with imaging devices. As long as the holding device 20 includes a column 21 whose height can be changed by the signal conversion device 40, other embodiments are optional.

(2) In the embodiments described above, an embodiment was illustrated in which the operation element for tilting rotation is used as the operation element for changing the height of the column 21. However, the operation element for controlling panning rotation or the operation element for controlling zooming (enlargement/reduction) may also be used as the operation element for changing the height of the column 21. However, according to the configuration in which the operation element for instructing rotation in the upward direction is used as the operation element for instructing to raise the height of the column 21, and the operation element for instructing rotation in the downward direction is used as the operation element for instructing to lower the height of the column 21, there is an advantage that the user can perform intuitive operations without making operational errors, as compared with a configuration in which the operation element for instructing panning rotation or the operation element for controlling zooming (enlargement/reduction) is used as the operation element for instructing to lower the height of the column 21. As understood from the above description, the content of the control signals (S1, S2) to be converted into the column control signal Sc is not limited to an instruction for tilting rotation, and instructions for various other operations (for example, panning rotation, zooming) or instructions for various settings (for example, preset position, focus adjustment, white balance adjustment) in the imaging device 10 may be adopted.

(3) In the embodiments described above, in the N first operating devices 30 (N first control protocols P1), the operation element 31 used as the operation element for instructing to raise the height of the column 21 and the operation element for instructing to lower the height of the column 21 were made common. However, for each first operating device 30 (first control protocol P1), the operation element 31 used as the operation element for instructing to raise the height of the column 21 and the operation element 31 used as the operation element for instructing to lower the height of the column 21 may be changed. However, according to the embodiment in which, among the N first control signals S1 converted into the column control signal Sc for instructing to raise the height of the column 21, the instructions represented by the first control signals S1 to the imaging device 10 are common, and among the N first control signals S1 converted into the column control signal Sc for instructing to lower the height of the column 21, the instructions represented by the first control signals S1 to the imaging device 10 are also common, there is an advantage that even when the user switches between the first operating devices 30 of a plurality of different imaging devices 10, the operation is common, and thus operational errors are reduced. The same applies to the K second operating devices 50.

(4) In the embodiments described above, it is preferable that the signal conversion device 40 be detachably attached to the holding device 20. For example, the signal conversion device 40 may be provided with a belt-shaped connecting mechanism, and by winding this connecting mechanism around the outer circumferential surface of the housing part 23 of the holding device 20, the signal conversion device 40 can be attached to the holding device 20. However, it is not essential that the signal conversion device 40 be detachable. For example, the signal conversion device 40 may be built into the holding device 20. However, according to the embodiment in which the signal conversion device 40 is detachable, there are advantages in that the signal conversion device 40 can be retrofitted to the holding device 20 and that the signal conversion device 40 and the holding device 20 can be carried separately.

(5) In the embodiments described above, the first communication scheme may be a communication scheme other than serial communication (for example, IP communication). Similarly, the second communication scheme may be a communication scheme other than IP communication (for example, serial communication). In addition, various communication schemes other than serial communication and IP communication may be adopted for the first communication scheme and the second communication scheme.

(6) In the embodiments described above, the holding device 20 may also be operated using an information terminal (for example, a smartphone, tablet terminal, or personal computer) on which a dedicated application program for controlling the holding device 20 is installed. The signal conversion device 40 receives, from the information terminal, a signal for controlling the height of the column 21 through serial communication or IP communication. For example, in the case of serial communication, a USB cable is used, and in the case of IP communication, a LAN cable is used. The conversion unit 414 of the signal conversion device 40, as necessary, converts the signal transmitted from the information terminal into a signal of a communication scheme that the holding device 20 can receive (that is, a signal corresponding to the control protocol adopted in the holding device 20) and transmits it to the holding device 20. That is, the signal conversion device 40 also functions as an element that converts a signal transmitted from the information terminal into a signal in a format usable by the holding device 20, while maintaining the content of the instruction that the transmitted signal represents.

(7) In the embodiments described above, for example, the signal conversion device 40 may be used to operate an imaging device (hereinafter referred to as “imaging device B”) of a different model from the imaging device 10 (hereinafter referred to as “imaging device A”) held by the holding device 20. For example, a control signal transmitted from the imaging device A (hereinafter referred to as “control signal A”) is converted into a control signal usable by the imaging device B (hereinafter referred to as “control signal B”). The conversion unit 414 of the signal conversion device 40 refers, for example, to a data table in which the control signal A is associated with each of a plurality of control signals B, converts the control signal A into the control signal B, and transmits it to the imaging device B. As understood from the above description, the signal conversion device 40 is used to operate various devices other than the imaging device A held by the holding device 20 (such as the imaging device B or devices other than imaging devices).

(8) In the embodiments described above, together with the column control signal Sc, a signal indicating the movement speed of the column 21 (hereinafter referred to as “column speed signal”) is transmitted. For example, when a signal indicating the speed of a predetermined operation (hereinafter referred to as “third control signal”) is transmitted to the holding device 20 together with the first control signal S1, the height of the column 21 is changed at a movement speed corresponding to the speed represented by the third control signal. Specifically, this is as follows. In the following description, an embodiment is illustrated in which the third control signal is a signal indicating the speed of tilting rotation.

For example, it is possible to set the speed of tilting rotation (for example, angular velocity or rotational speed) by using an operation element 31 for controlling the speed of tilting rotation (hereinafter referred to as “speed operation element 31”). For example, the speed operation element 31 may be in the form of a lever, and the rotation speed can be set such that the shallower the tilt of the speed operation element 31, the slower the rotation speed, and the deeper the tilt, the faster the rotation speed. When an operation is received through the operation element 31 for tilting rotation (the operation element for upward rotation/the operation element for downward rotation), the first control signal S1 that instructs to perform the tilting rotation and the third control signal representing the speed of the tilting rotation are transmitted from the first operating device 30 to the signal conversion device 40. That is, both the instruction for tilting rotation and the speed of the tilting rotation are transmitted to the signal conversion device 40.

The first acquisition unit 412 acquires the first control signal S1 and the third control signal from the first operating device 30. The conversion unit 414 converts the first control signal S1 into a column control signal Sc and converts the third control signal into a column speed signal. For example, the conversion unit 414 converts the speed represented by the column speed signal into the movement speed of the column 21 and generates a column speed signal representing the movement speed after conversion. For example, the third control signal is converted into the column speed signal by using a previously stored conversion table (a table in which the tilting rotation speed is associated with the movement speed of the column 21). In the conversion table, the tilting rotation speed and the movement speed of the column 21 are associated with each other for each first control protocol P1. Alternatively, the column speed signal may be generated by calculating a movement speed indicated by a relative position within a range in which the movement speed of the column can be set (a position corresponding to the relative position of the speed indicated by the third control signal within a range in which the tilting rotation speed can be set). When the column control signal Sc and the column speed signal are transmitted to the holding device 20, the holding device 20 performs the operation represented by the column control signal Sc (raising or lowering the height of the column 21) at the movement speed represented by the column speed signal.

In the above example, an embodiment was illustrated in which the movement speed of the column 21 is instructed by the operation element 31 for controlling the speed of tilting rotation. However, the movement speed of the column 21 may alternatively be instructed by using the operation element 31 for controlling the speed of panning rotation or another operation element 31 related to speed. That is, the third control signal is not limited to a signal indicating the speed of tilting rotation, and may be any signal indicating the speed of some operation of the imaging device 10.

As understood from the above description, the first acquisition unit 412 acquires, together with the first control signal S1, a third control signal representing the speed of a predetermined operation (for example, panning rotation or tilting rotation) of the imaging device 10 corresponding to the first control signal S1, and the conversion unit 414 converts the third control signal acquired by the first acquisition unit 412 into a column speed signal that instructs the movement speed of the column 21. Each third control signal is based on the same first control protocol P1 as the first control signal S1 transmitted from the common first operating device 30. Similarly, in the case of the second operating device 50, an embodiment may be adopted in which the column speed signal is transmitted to the holding device 20 together with the column control signal Sc by an operation performed on the second operating device 50.

(9) The signal conversion device 40 may be implemented, for example, by an information terminal such as a smartphone, tablet terminal, or personal computer. The signal conversion device 40 may be realized not only as a single standalone device but also as a combination of a plurality of separate devices configured independently of each other.

(10) The functions of the signal conversion device 40 according to the embodiments described above may be realized by cooperation between a computer (for example, the control device 41) and a program, or may be realized by a dedicated circuit. A program according to a preferred embodiment of the present invention is provided in a form stored on a computer-readable recording medium and installed in a computer. The recording medium is, for example, a non-transitory recording medium, with an optical recording medium such as a CD-ROM (optical disk) being a typical example, but it also includes any known form of recording medium such as a semiconductor recording medium or a magnetic recording medium. The term “non-transitory recording medium” includes any recording medium except for transitory propagating signals and does not exclude volatile recording media. The program may also be provided to the computer in a distribution form via a communication network.

### DESCRIPTION OF REFERENCE NUMERALS

10: Imaging device
20: Holding device
21: Column
23: Housing part
25: Leg part
30: First operating device
40: Signal conversion device
41: Control device
43: Storage device
45: Display device
47: Input device
100: Imaging system
211: Pole part
213: Connecting part
412: First acquisition unit
414: Conversion unit
416: Second acquisition unit
P1: First control protocol
S1: First control signal
S2: Second control signal
Sc: Column control signal

1. A signal conversion device comprising:
a first acquisition unit that acquires each of N (where N is an integer of 2 or more) first control signals for respectively controlling N first imaging devices; and
a conversion unit that converts the first control signal acquired by the first acquisition unit into a column control signal for changing the height of a column in a holding device capable of holding each of the N first imaging devices,
wherein each of the N first control signals is a signal generated in each of N first operating devices corresponding respectively to the N first imaging devices and transmitted from the respective first operating device by a first communication scheme,
and wherein each of the N first control signals corresponds to a different protocol for controlling the respective N first imaging devices.

2. The signal conversion device according to claim 1,
wherein the holding device is capable of holding a second imaging device,
further comprising a second acquisition unit that acquires a second control signal for controlling the second imaging device,
wherein the conversion unit converts the second control signal acquired by the second acquisition unit into the column control signal,
and wherein the second control signal is a signal generated in a second operating device corresponding to the second imaging device and transmitted from the second operating device by a second communication scheme different from the first communication scheme.

3. The signal conversion device according to claim 1,
wherein, among the N first control signals converted into the column control signals for instructing to raise the height of the column, the instructions represented by the first control signals with respect to the first imaging device are common,
and wherein, among the N first control signals converted into the column control signals for instructing to lower the height of the column, the instructions represented by the first control signals with respect to the first imaging device are common.

4. The signal conversion device according to claim 1,
wherein the first imaging device is capable of panning rotation and tilting rotation,
and wherein, when the first acquisition unit acquires a first control signal for instructing upward rotation in the tilting rotation, the conversion unit converts the first control signal into a column control signal for instructing to raise the height of the column,
and when the first acquisition unit acquires a first control signal for instructing downward rotation in the tilting rotation, the conversion unit converts the first control signal into a column control signal for instructing to lower the height of the column.

5. The signal conversion device according to claim 1,
which is attachable to and detachable from the holding device.

6. The signal conversion device according to claim 1,
wherein the first acquisition unit acquires, together with the first control signal, a third control signal representing a speed related to a predetermined operation of the first imaging device corresponding to the first control signal,
and wherein the conversion unit converts the third control signal acquired by the first acquisition unit into a column speed signal for instructing a moving speed of the column.

7. A signal conversion method implemented by a computer, comprising:
acquiring each of N first control signals for respectively controlling N first imaging devices, where N is an integer of 2 or more;
converting each of the acquired first control signals into a column control signal for changing a height of a column in a holding device capable of holding each of the N first imaging devices;
wherein each of the N first control signals is a signal generated in a corresponding one of N first operating devices respectively corresponding to the N first imaging devices and transmitted from the first operating device by a first communication scheme; and
wherein each of the N first control signals corresponds to a different protocol for controlling a corresponding one of the N first imaging devices.

8. A non-transitory computer-readable medium storing instructions that, when executed by a computer, cause the computer to:
acquire each of N first control signals for respectively controlling N first imaging devices, where N is an integer of 2 or more; and
convert each of the first control signals acquired by the first acquisition unit into a column control signal for changing a height of a column in a holding device capable of holding each of the N first imaging devices;
wherein each of the N first control signals is a signal generated in a corresponding one of N first operating devices respectively corresponding to the N first imaging devices and transmitted from the first operating device by a first communication scheme; and
wherein each of the N first control signals corresponds to a different protocol for controlling a corresponding one of the N first imaging devices.
